(19) United States
(12) Patent Application Publication
(10) Pub. No.: US 2011/0163990 A1
(43) Pub. Date: Jul. 7, 2011

(54) INFORMATION PROCESSING DEVICE, INFORMATION PROCESSING DEVICE CONTROL METHOD, PROGRAM, AND INFORMATION STORAGE MEDIUM

(75) Inventor: Takahiro Sakiyama, Tokyo (JP)

(73) Assignee: KONAMI DIGITAL ENTERTAINMENT CO., LTD., Tokyo (JP)

(21) Appl. No.: 13/119,077

(22) PCT Filed: Jun. 3, 2009
(86) PCT No.: PCT/JP2009/060178

§ 371 Date: Mar. 15, 2011

(30) Foreign Application Priority Data
Sep. 19, 2008 (JP) 2008-241806

(51) Int. Cl. G06F 3/041

(52) U.S. Cl. 345/173

(57) ABSTRACT

To provide an information processing device capable of improving operability of the information processing device in which, if an input of a position in a reference region that is set on a screen is received, processing corresponding to the reference region is executed. First execution means (84) executes, if the input of the position in the reference region that is set on the screen is received, the processing corresponding to the reference region. Determination means (86) determines, if an input of a locus having a start point thereof positioned outside the reference region is received, whether or not the locus and the reference region have a predetermined relation to each other. Second execution means (88) executes, if it is determined that the locus and the reference region have the predetermined relation to each other, the processing corresponding to the reference region.

### TECHNICAL FIELD

The present invention relates to an information processing device, a method of controlling an information processing device, a program, and an information storage medium.

### BACKGROUND ART

There is known an information processing device that executes, in a case where an input of a position in a reference region that is set on a screen is received, processing corresponding to the reference region.

For example, there is known an information processing device that employs a so-called software keyboard technology. With this information processing device, a plurality of reference regions corresponding to a plurality of characters (or character groups) are set on a screen. In order to input a desired character, a user points at a position in the reference region corresponding to the desired character (or character group to which the desired character belongs).

Further, for example, there is known an information processing device that executes processing corresponding to an option selected by a user from among a plurality of options. With this information processing device, a plurality of reference regions corresponding to options (or option groups) are set on a screen. In order to select a desired option, the user points to a position in the reference region corresponding to the desired option (or option group to which the desired option belongs).

### PRIOR ART DOCUMENT

### Patent Document

Patent Document 1: JP 2006-55294 A

### DISCLOSURE OF THE INVENTION

### Problems to be Solved by the Invention

With such information processing devices as described above, there is a case in which operability for the user is impaired. For example, there is a case in which the user has difficulty in inputting a symbol or selecting an option when symbol input or option selection is performed in an information processing device. Specifically, if a plurality of reference regions corresponding to symbols (symbol groups) or options (option groups) are set on a screen having a small area, the respective reference regions are made smaller and are located close to each other. Consequently, there occurs a case in which the user has difficulty in pointing to a position in the reference region corresponding to the desired symbol (or symbol group to which the desired symbol belongs) or to a position in the reference region corresponding to the desired option (or option group to which the desired option belongs).

The present invention has been made in view of the above-mentioned problem, and it is an object of the present invention to provide an information processing device, a method of controlling an information processing device, a program, and an information storage medium, which are capable of improving operability of the information processing device in which, in a case where an input of a position in a reference region that is set on a screen is received, processing corresponding to the reference region is executed.

### Means for Solving the Problems

In order to solve the above-mentioned problem, an information processing device according to the present invention includes: first execution means for executing, if an input of a position in a reference region that is set on a screen is received, processing corresponding to the reference region; determination means for determining, if an input of a locus having a start point thereof positioned outside the reference region is received, whether or not the locus and the reference region have a predetermined relation to each other; and second execution means for executing, if it is determined that the locus and the reference region have the predetermined relation to each other, the processing corresponding to the reference region.

Further, a method of controlling an information processing device according to the present invention includes: a first execution step of executing, if an input of a position in a reference region that is set on a screen is received, processing corresponding to the reference region; a determination step of determining, if an input of a locus having a start point thereof positioned outside the reference region is received, whether or not the locus and the reference region have a predetermined relation to each other; and a second execution step of executing, if it is determined that the locus and the reference region have the predetermined relation to each other, the processing corresponding to the reference region.

Further, a program according to the present invention causes a computer, such as a stationary game machine (consumer game machine), a portable game machine, an arcade game machine, a mobile phone, a personal digital assistant (PDA), or a personal computer, to function as: first execution means for executing, if an input of a position in a reference region that is set on a screen is received, processing corresponding to the reference region; determination means for determining, if an input of a locus having a start point thereof positioned outside the reference region is received, whether or not the locus and the reference region have a predetermined relation to each other; and second execution means for executing, if it is determined that the locus and the reference region have the predetermined relation to each other, the processing corresponding to the reference region.

Further, an information storage medium according the present invention is a computer-readable information storage medium storing the above-mentioned program.

According to the present invention, it is possible to improve the operability of the information processing device in which, if an input of a position in the reference region that is set on the screen is received, the processing corresponding to the reference region is executed.

Further, according to an aspect of the present invention, the information processing device may include reference symbol sequence storage means for storing a reference symbol sequence including one or a plurality of symbols. A plurality of the reference regions each corresponding to a symbol or a symbol group may be set on the screen. The first execution means may execute, if an input of a position in any one of the plurality of the reference regions is received, processing related to the symbol or the symbol group corresponding to the any one of the plurality of the reference regions. The determination means may determine, if an input of a locus having a start point thereof positioned outside a particular reference region is received, whether or not the locus and the particular reference region have the predetermined relation to each other, the particular reference region being the reference region corresponding to the symbol included in the reference symbol sequence or the reference region corresponding to the symbol group to which the symbol included in the reference symbol sequence belongs. The second execution means may execute, if it is determined that the locus and the particular reference region have the predetermined relation to each other, the processing related to the symbol or the symbol group corresponding to the particular reference region.

Note that, in this description, the claims, the drawings, and the abstract, the “symbol” means broadly-defined symbols, and includes, for example, characters, signs (narrowly-defined symbols), pictograms, and the like. Further, the “symbol sequence” also includes a symbol sequence consisting of one symbol (that is, a single symbol).

Further, according to an aspect of the present invention, if a user inputs an x-th symbol, where x is an integer equal to or larger than 1, the particular reference region may be the reference region corresponding to the x-th symbol of the reference symbol sequence or the reference region corresponding to the symbol group to which the x-th symbol of the reference symbol sequence belongs.

Further, according to an aspect of the present invention, the information processing device may include reference option storage means for storing a reference option. A plurality of the reference regions each corresponding to an option or an option group may be set on the screen. The first execution means may execute, if an input of a position in any one of the plurality of the reference regions is received, processing related to the option or the option group corresponding to the any one of the plurality of the reference regions. The determination means may determine, if an input of a locus having a start point thereof positioned outside a particular reference region is received, whether or not the locus and the particular reference region have the predetermined relation to each other, the particular reference region being the reference region corresponding to the option serving as the reference option or the reference region corresponding to the option group to which the option serving as the reference option belongs. The second execution means may execute, if it is determined that the locus and the particular reference region have the predetermined relation to each other, the processing related to the option or the option group corresponding to the particular reference region.

Further, according to an aspect of the present invention, the determination means may include first determination means for determining whether or not at least part of the locus is included in a peripheral region that is set on a periphery of the particular reference region, and second determination means for determining whether or not a first direction, which extends from a representative position corresponding to the locus to a representative position corresponding to the particular reference region, and a second direction corresponding to the locus, have the predetermined relation to each other. The second execution means may execute, if it is determined that the at least part of the locus is included in the peripheral region and that the first direction and the second direction have the predetermined relation to each other, the processing corresponding to the particular reference region.

### BRIEF DESCRIPTION OF THE DRAWINGS

FIG. 1 is a perspective view illustrating an outer appearance of a game device according to first and second embodiments.

FIG. 2 is a diagram illustrating an outer appearance of the game device according to the first and second embodiments.

FIG. 3 is a diagram illustrating a hardware configuration of the game device according to the first and second embodiments.

FIG. 4 is a diagram illustrating an example of an answer screen according to the first embodiment.

FIG. 5 is a diagram illustrating an example of key regions.

FIG. 6 is a functional block diagram of the game device according to the first embodiment.

FIG. 7 is a flow chart illustrating processing executed by the game device according to the first embodiment.

FIG. 8 is a flow chart illustrating the processing executed by the game device according to the first embodiment.

FIG. 9 is a flow chart illustrating the processing executed by the game device according to the first embodiment.

FIG. 10 is a diagram illustrating an example of a locus.

FIG. 11 is a diagram for describing an example of a peripheral region of a character key region X.

FIG. 12 is a diagram for describing an example of details of the processing executed by the game device.

FIG. 13 is a diagram illustrating an example of an answer screen according to the second embodiment.

FIG. 14 is a diagram illustrating an example of option regions.

FIG. 15 is a functional block diagram of the game device according to the second embodiment.

FIG. 16 is a flow chart illustrating processing executed by the game device according to the second embodiment.

### BEST MODE FOR CARRYING OUT THE INVENTION

### First Embodiment

Hereinbelow, detailed description is given of an example of an embodiment of the present invention with reference to the drawings. Here, description is given of a case in which the present invention is applied to a game device which is one aspect of an information processing device. Further, description is herein given of a case in which the game device according to the embodiment of the present invention is implemented using a portable game machine. Note that the game device may also be implemented using a stationary game machine (consumer game machine), an arcade game machine, a mobile phone, a personal digital assistant (PDA), a personal computer, or the like. Further, the present invention is also applicable to an information processing device other than the game device.

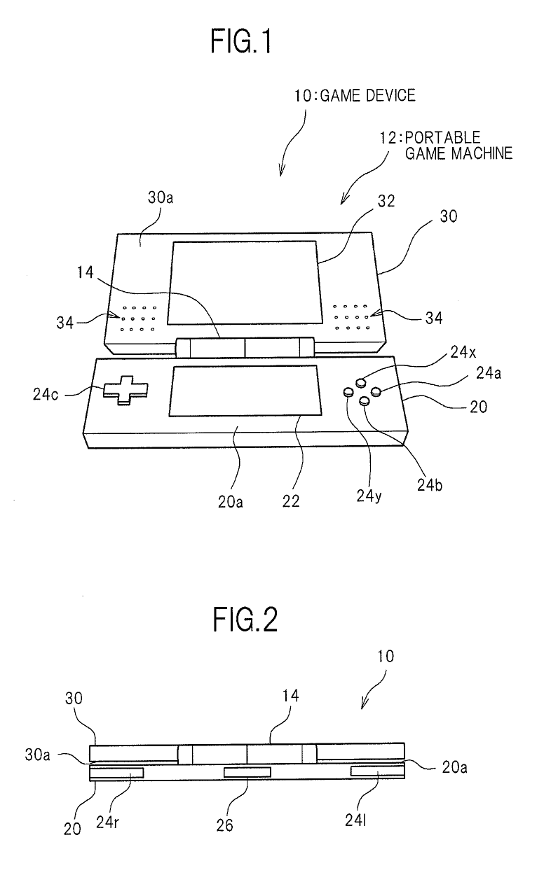

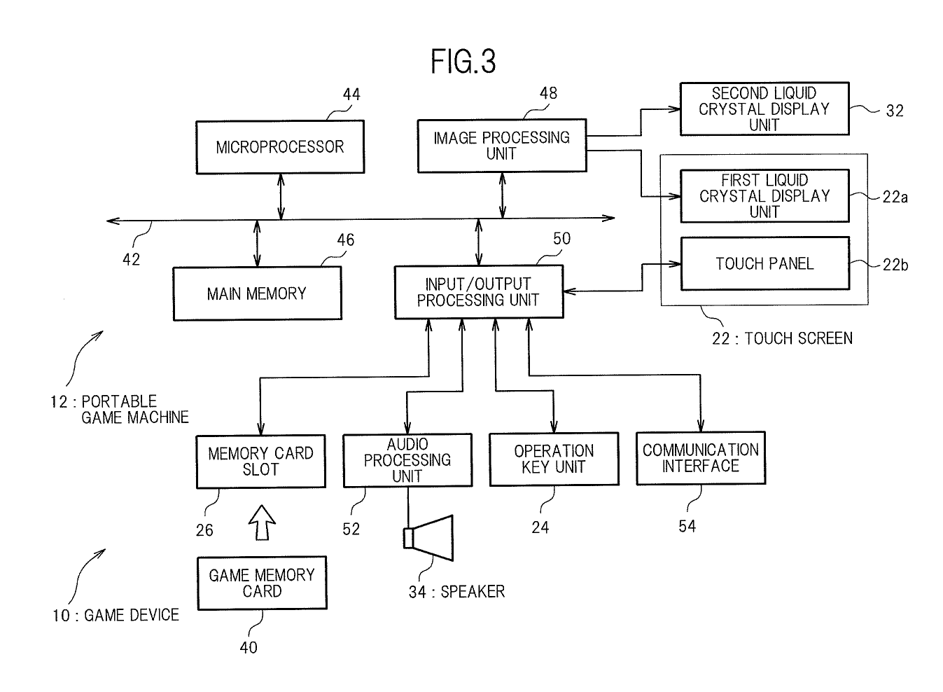

FIG. 1 and FIG. 2 each illustrate an outer appearance of a game device 10 (portable game machine 12) according to a first embodiment of the present invention. FIG. 3 illustrates a hardware configuration of the game device 10 according to this embodiment.

FIG. 1 is a perspective view illustrating an appearance of the game device 10 when viewed from the front. As illustrated in FIG. 1, the game device 10 includes a first casing 20 and a second casing 30. The first casing 20 and the second casing 30 are coupled to each other by means of a hinge part 14. A touch screen 22, a cross-shaped button 24c, and buttons 24a, 24b, 24x, and 24y are provided on a top surface 20a of the first casing 20. The touch screen 22 includes a first liquid crystal display unit 22a and a touch panel 22b placed over the first liquid crystal display unit 22a (see FIG. 3). The cross-shaped button 24c is used for an operation for specifying a direction, for example. The buttons 24a, 24b, 24x, and 24y are used for various kinds of operations. A second liquid crystal display unit 32 is provided on a top surface 30a of the second casing 30. Further, a speaker 34 is built into the second casing 30.

FIG. 2 is a rear view of the game device 10 in a folded state (state in which the top surface 20a of the first casing 20 and the top surface 30a of the second casing 30 are placed one on the other). As illustrated in FIG. 2, buttons 24l and 24r are provided at the left and right of the rear side of the first casing 20, respectively. Further, a memory card slot 26 into which a game memory card 40 (see FIG. 3) serving as an information storage medium can be inserted is provided at the center of the rear side of the first casing 20. Note that other components (not shown), such as a power switch, may also be mounted onto the game device 10.

As illustrated in FIG. 3, the game device 10 includes the touch screen 22 (first liquid crystal display unit 22a and touch panel 22b), an operation key unit 24, the memory card slot 26, the second liquid crystal display unit 32, the speaker 34, a bus 42, a microprocessor 44, a main memory 46, an image processing unit 48, an input/output processing unit 50, an audio processing unit 52, and a communication interface 54. Those components are accommodated together with a battery (not shown) in the casings, and are driven by the battery.

The microprocessor 44 executes various kinds of information processing based on an operating system stored in a ROM (not shown) and programs stored in the game memory card 40. The main memory 46 includes a RAM, for example, and a program read from the game memory card 40 is written into the main memory 46 as needed. The main memory 46 is also used as a working memory for the microprocessor 44. The bus 42 is used for exchanging addresses and data among the components of the game device 10. The microprocessor 44, the main memory 46, the image processing unit 48, and the input/output processing unit 50 are connected to one another so as to communicate data among them.

The first liquid crystal display unit 22a and the second liquid crystal display unit 32 are publicly-known liquid crystal display panels. The image processing unit 48 includes a VRAM, and renders an image in the VRAM according to an instruction from the microprocessor 44. The image rendered in the VRAM is displayed on the first liquid crystal display unit 22a or the second liquid crystal display unit 32 at a predetermined time.

The input/output processing unit 50 is an interface for the microprocessor 44 to exchange data with the touch panel 22b, the operation key unit 24, the memory card slot 26, the audio processing unit 52, and the communication interface 54. The input/output processing unit 50 is connected to the touch panel 22b, the operation key unit 24, the memory card slot 26, the audio processing unit 52, and the communication interface 54.

The operation key unit 24 is means for receiving an operation input made by a user. The operation key unit 24 includes the cross-shaped button 24c, and the buttons 24a, 24b, 24x, 24y, 24l, and 24r. The input/output processing unit 50 scans the state of each part of the operation key unit 24 at fixed intervals (for example, every 1/60^{th} of a second), and then supplies an operation signal indicating a result of the scan to the microprocessor 44 via the bus 42. The microprocessor 44 determines an operation content of the user based on the operation signal. The touch panel 22b is means for receiving an operation input made by the user as well. Specifically, the touch panel 22b receives a positional input. The touch panel 22b supplies pressed-position information according to a position pressed by the user to the microprocessor 44 via the input/output processing unit 50. The microprocessor 44 determines the position pressed by the user based on the pressed-position information.

The memory card slot 26 reads a game program and game data stored in the game memory card 40 therefrom according to an instruction from the microprocessor 44. The game memory card 40 includes a ROM in which the game program and the game data are stored and an EEPROM in which the game data, such as save data, is stored. Note that in this description, the game memory card 40 is used to supply the game program and the game data to the game device 10, but another information storage medium, such as an optical disk, may be used as well. Alternatively, the game program and the game data may be supplied to the game device 10 from a remote location via a communication network, such as the Internet. Alternatively, the game program and the game data may be supplied to the game device 10 by using various kinds of data communications, such as infrared communication.

The audio processing unit 52 includes a sound buffer, and outputs, from the speaker 34, various kinds of audio data loaded from the game memory card 40 into the sound buffer. The communication interface 54 is an interface for establishing connection to a communication network.

On the game device 10, for example, a quiz game is executed. The quiz game is implemented through execution of a program stored in the game memory card 40.

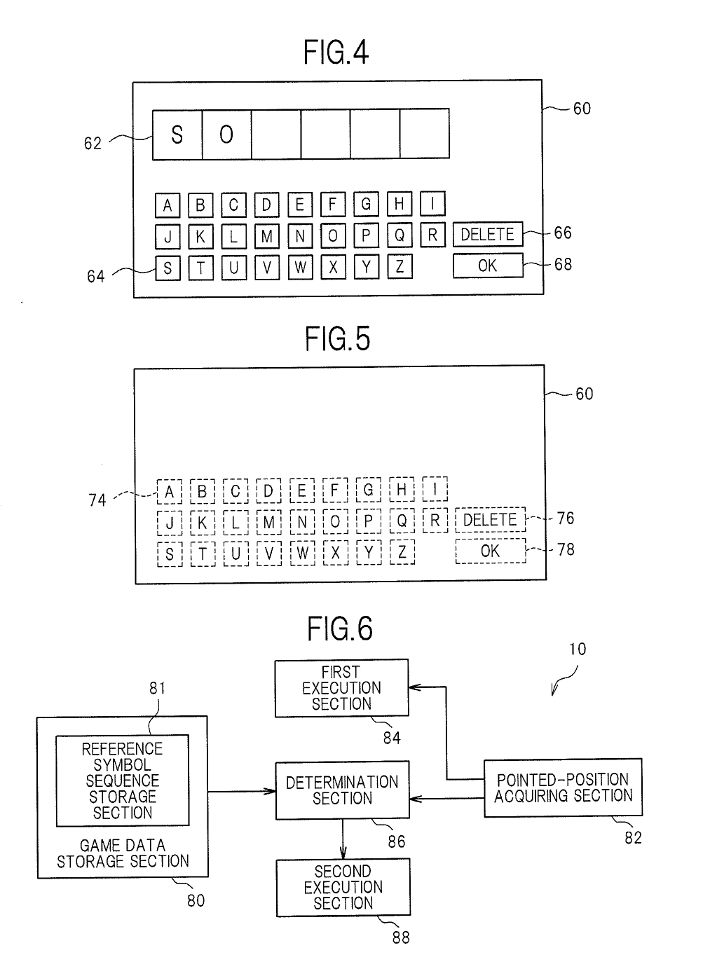

With the quiz game, a question screen showing a quiz question is displayed on the second liquid crystal display unit 32, whereas an answer screen for the user to input their answer to the quiz is displayed on the touch screen 22. FIG. 4 illustrates an example of the answer screen. As illustrated in FIG. 4, an answer screen 60 includes an answer field 62 and a plurality of key images. The answer field 62 is a field for displaying a string (answer) input by the user. Further, in this embodiment, the key images include character keys 64, a delete key 66, and an OK key 68. The character keys 64 are key images corresponding to the characters of the alphabet. The character keys 64 have the same size. The delete key 66 is a key image for deleting one character at the end of a string displayed in the answer field 62. The OK key 68 is a key image for confirming, as the answer to the quiz, the string displayed in the answer field 62.

Further, in the answer screen 60, key regions (reference regions), which are regions corresponding to the respective key images, are set. FIG. 5 illustrates an example of the key regions set on the answer screen 60. As illustrated in FIG. 5, character key regions 74 corresponding to the respective character keys 64, a delete key region 76 corresponding to the delete key 66, and an OK key region 78 corresponding to the OK key 68 are set. The key regions are set so as not to overlap each other. For example, a key region coincides with a region occupied by the key image corresponding to that key region. In a case where a position pointed to by the user is included in any one of the key regions, it is determined that the key image corresponding to that key region has been pointed to. The user points to the character keys 64 with their thumb or finger, or a stylus pen, to thereby input a string (answer to the quiz). If the user has pointed to the OK key 68, the string displayed in the answer field 62 is confirmed, and it is then determined whether or not the string is a correct answer.

Note that in the example illustrated in FIG. 4 and FIG. 5, the key images and the key regions have rectangular shapes, but the key images and the key regions may have a shape other than a rectangle (for example, circle).

Hereinbelow, description is given of a technology for allowing the user to input their answer with greater ease.

FIG. 6 is a functional block diagram illustrating functions implemented by the game device 10. As illustrated in FIG. 6, the game device 10 includes a game data storage section 80, a pointed-position acquiring section 82, a first execution section 84, a determination section 86, and a second execution section 88. The game data storage section 80 is implemented by, for example, the game memory card 40 or the main memory 46, and the other functional blocks are implemented by the microprocessor 44 executing the program read from the game memory card 40.

The game data storage section 80 stores various kinds of data regarding the quiz game. For example, data indicating the positions of key images and of key regions is stored in the game data storage section 80.

The game data storage section 80 includes a reference symbol sequence storage section 81. The reference symbol sequence storage section 81 stores a reference symbol sequence. For example, the reference symbol sequence storage section 81 stores a plurality of pieces of quiz data. The quiz data includes a string indicating a quiz question and a string indicating a correct answer to the quiz (hereinbelow, referred to as “correct answer string”). In this case, the correct answer string corresponds to the “reference symbol sequence”.

The pointed-position acquiring section 82 acquires a position on the touch panel 22b pointed to by the user. For example, based on the pressed-position information output from the touch panel 22b, the pointed-position acquiring section 82 acquires the position pressed by the user at predetermined intervals (for example, every 1/60^{th} of a second).

If a position acquired by the pointed-position acquiring section 82 is included in a certain key region (here, referred to as “key region A”), the first execution section 84 executes processing corresponding to the key region A. For example, if the key region A is the character key region, processing related to the character corresponding to the key region A is executed. Specifically, processing of inputting or outputting the character corresponding to the key region A is executed.

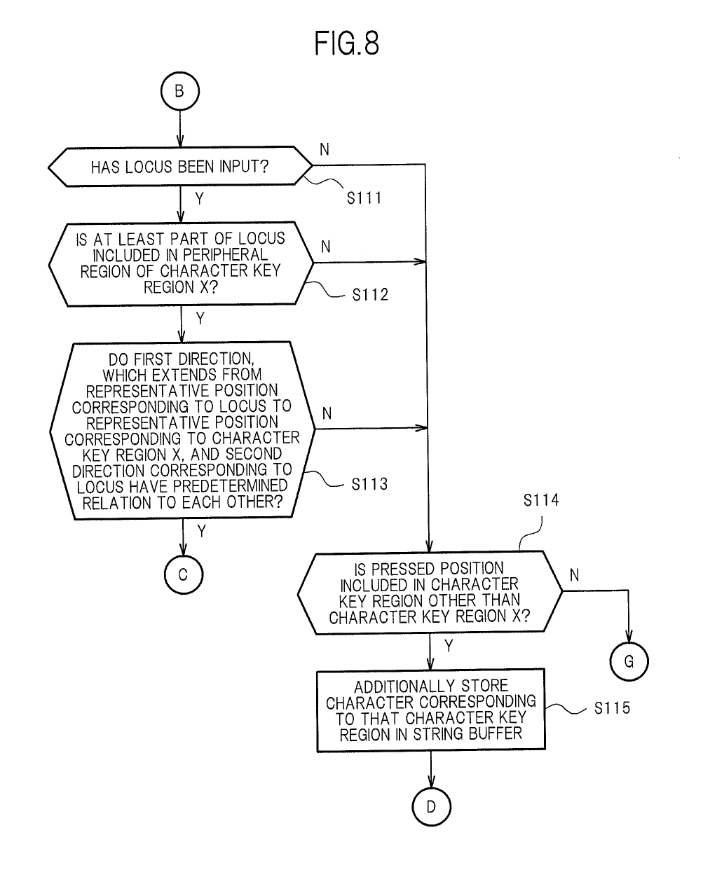

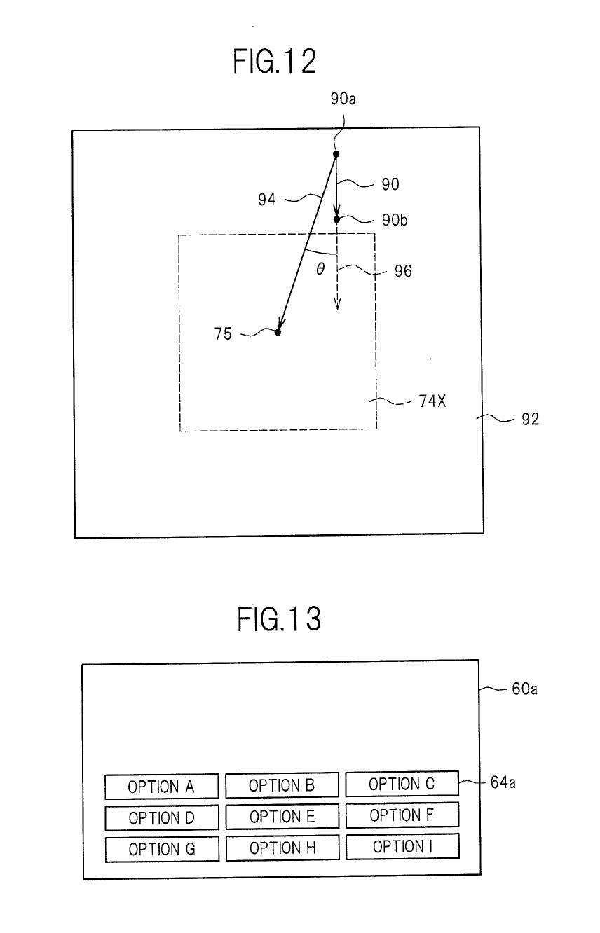

If an input of a locus having a start point thereof positioned outside the key region A is received, that is, if a locus of the positions acquired by the pointed-position acquiring section 82 has the start point thereof positioned outside the key region A, the determination section 86 determines whether or not the locus and the key region A have a predetermined relation to each other. Details of operation of the determination section 86 are described later (see S112 and S113 of FIG. 8 and FIG. 12).

If it is determined by the determination section 86 that the locus and the key region A have the predetermined relation to each other, the second execution section 88 executes processing corresponding to the key region A. Specifically, the same processing as the processing executed by the first execution section 84 in a case where the position acquired by the pointed-position acquiring section 82 is included in the key region A is executed.

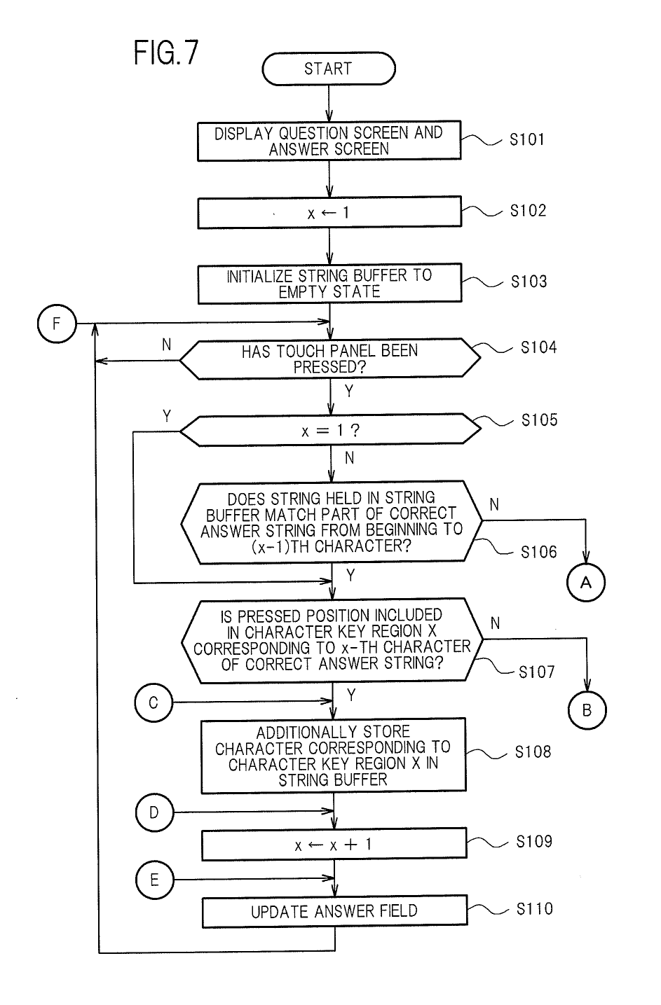

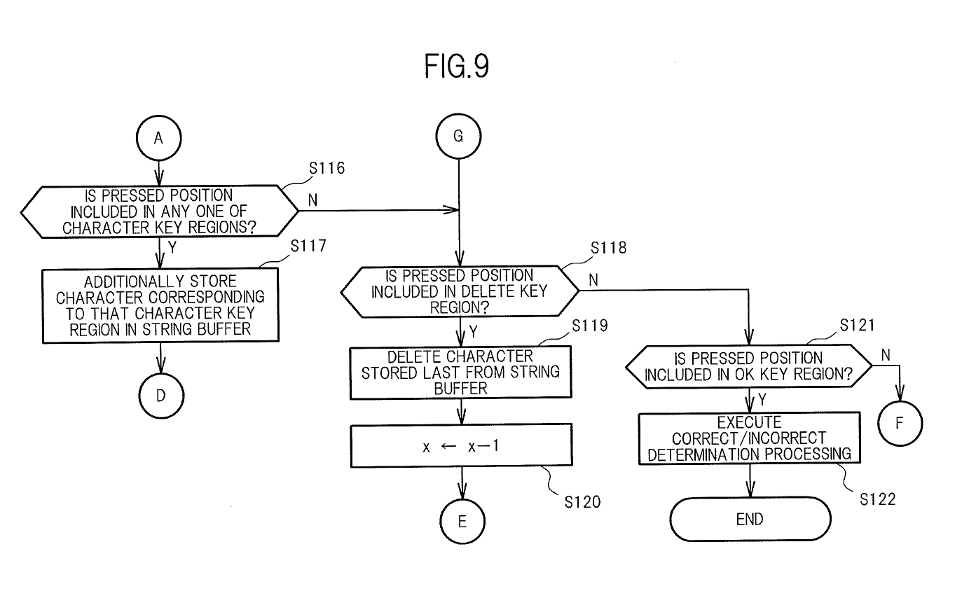

Next, description is given of processing executed by the game device 10. FIG. 7, FIG. 8, and FIG. 9 are flow charts illustrating the processing executed by the game device 10 according to this embodiment. The microprocessor 44 executes the processing illustrated in FIGS. 7 to 9 according to the program read from the game memory card 40.

As illustrated in FIG. 7, first, the microprocessor 44 displays a question screen on the second liquid crystal display unit 32, and displays the answer screen 60 on the touch screen 22 (S101). In this processing, any one of the plurality of pieces of quiz data stored in the game memory card 40 is read, and a quiz question is displayed on the question screen. Further, the microprocessor 44 initializes a variable x to 1 (S102). The variable x is used for counting the number of characters input by the user. Further, the microprocessor 44 initializes a string buffer to an empty state (S103). The string buffer is used for holding the string input by the user. Specifically, in the string buffer, the characters specified by the user are stored in order of their being specified.

After that, the microprocessor 44 monitors whether or not the user has pressed the touch panel 22b (S104). If the touch panel 22b has been pressed, the microprocessor 44 (pointed-position acquiring section 82) acquires the pressed position as a position pointed to by the user. Then, the microprocessor 44 determines whether or not the value of the variable x is 1 (S105). Specifically, it is determined whether or not the user is inputting the first character. If the value of the variable x is not 1, that is, if the user is inputting the second or subsequent character, the microprocessor 44 determines whether or not the string held in the string buffer matches part of the correct answer string from the beginning to an (x-1)th character (S106). Specifically, it is determined whether or not the user has already input the part of the correct answer string up to the (x-1)th character.

If it is determined in S105 that the value of the variable x is 1, or if it is determined in S106 that the string held in the string buffer matches the above-mentioned part of the correct answer string, the microprocessor 44 determines whether or not the position pointed to by the user (pressed position) is included in a character key region X (particular reference region), which is the character key region 74 corresponding to an x-th character of the correct answer string (S107). If the position pointed to by the user is included in the character key region X, the microprocessor 44 (first execution section 84) additionally stores the character corresponding to the character key region X in the string buffer (S108). Further, the microprocessor 44 adds one to the value of the variable x (S109), and then updates the answer field 62 of the answer screen 60 (S110). Specifically, the string stored in the string buffer is displayed in the answer field 62.

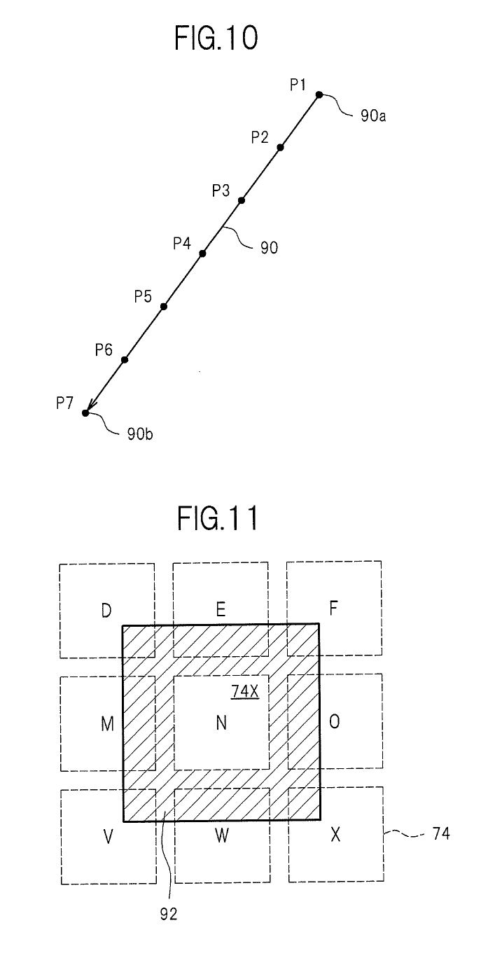

On the other hand, if the position pointed to by the user is not included in the character key region X, as illustrated in FIG. 8, the microprocessor 44 determines whether or not a locus has been input (S111). For example, it is determined whether or not a slide operation has been performed. The “slide operation” refers to an operation of sliding a stylus pen (or thumb or finger or the like) on the touch panel 22b, that is, an operation in which a stylus pen is moved with the touch panel 22b being pressed with the stylus pen. If the slide operation has been performed, positions (P1, P2, P3, P4, P5, P6, and P7) pointed to by the user at predetermined intervals (for example, every 1/60^{th} of a second) as illustrated in FIG. 10, for example, are acquired, and those pointed positions are acquired as data indicating a locus 90 input through the slide operation. Note that in the example illustrated in FIG. 10, the pointed position P1 corresponds to a start point 90a of the locus 90, and the pointed position P7 corresponds to an end point 90b of the locus 90.

If the locus has been input, the microprocessor 44 (determination section 86) determines whether or not at least part of the locus is included in a peripheral region of the character key region X (S112). FIG. 11 is a diagram for describing an example of the peripheral region of the character key region X. In FIG. 11, the character key region 74 corresponding to a character “N” is referred to as a character key region X 74X, and a peripheral region 92 of the character key region X 74X is hatched. As illustrated in FIG. 11, the peripheral region 92 of the character key region X 74X is set on the periphery of the character key region X 74X in such a manner as to surround the character key region X 74X. In other words, of a region including the character key region X 74X, a part other than the character key region X 74X is set as the peripheral region 92 of the character key region X 74X. In the example illustrated in FIG. 11, of a rectangular region whose center point coincides with a center point of the character key region X 74X, and whose side is longer than a side of the character key region X 74X, a part other than the character key region X 74X is set as the peripheral region 92 of the character key region X 74X. Note that as illustrated in FIG. 11, the peripheral region 92 of the character key region X 74X includes part of the character key regions 74 positioned around the character key region X 74X.

If at least part of the locus is included in the peripheral region of the character key region X, the microprocessor 44 (determination section 86) determines whether or not a first direction, which extends from a representative position corresponding to the locus to a representative position corresponding to the character key region X, and a second direction corresponding to the locus, have a predetermined relation to each other (S113). FIG. 12 is a diagram for describing an example of details of the processing. For example, in the processing of S113, it is determined whether or not an angle θ formed between a first direction 94, which extends from the representative position (for example, start point 90a) of the locus 90 to the representative position (for example, center point 75) of the character key region X 74X, and a second direction 96 indicated by the locus 90, is less than a reference angle. Note that as the second direction 96 indicated by the locus 90, for example, a direction that extends from a first position (for example, start point 90a) on the locus 90 to a second position (for example, end point 90b) on the locus 90 is used. In this case, the second position is such a position on the locus 90 that is pointed to later than the first position.

If the first direction and the second direction have the predetermined relation to each other, the microprocessor 44 (second execution section 88) executes the same processing as the processing executed in the case where it is determined in S106 that the position pointed to by the user is included in the character key region X. Specifically, the character corresponding to the character key region X is additionally stored in the string buffer (S108), one is added to the value of the variable x one (S109), and the answer field 62 of the answer screen 60 is updated (S110).

A case in which all the above-mentioned conditions of S111 to S113 are satisfied means that the user has failed to point to a position in the character key region X, but has pointed to a position in the vicinity of the character key region X and moved the stylus pen or their thumb or finger toward the character key region X. In such a case, it is conceivable that the user intends to point to a position in the character key region X. In this respect, according to this embodiment, if all the conditions of S111 to S113 are satisfied, the user is considered to intend to point to a position in the character key region X, and hence the same processing as the processing executed in the case where the user has pointed to a position in the character key region X is executed, to thereby input the character corresponding to the character key region X. As a result, operability is improved for the user.

Note that, in this embodiment, only if the condition of S105 or S106 is satisfied, the processing of S111 to S113 is executed. A case in which the condition of S105 is satisfied means that the user is inputting the first character, whereas a case in which the condition of S106 is satisfied means that the user has already input the part of the correct answer string up to the (x-1)th character. In those cases, there is conceivably a high possibility that the user is inputting the correct answer string. In this embodiment, the processing of S111 to S113 is executed only in those cases, thereby allowing the user to input the x-th character of the correct answer string with greater ease. Specifically, it is made easier for the user who has figured out the correct answer to the quiz (user who is inputting an answer that is likely to be correct) to input the answer. On the other hand, a case in which the conditions of S105 and S106 are both not satisfied means that the user is inputting a string different from the correct answer string. In such a case, there is little need to enable the user to more easily input the x-th character of the correct answer string. On the contrary, if the x-th character of the correct answer string is made easier for the user to input, the user who intends to input another character may input the x-th character of the correct answer string unintentionally. In this respect, the game device 10 is so configured as to avoid such inconvenience.

Note that, if it is determined in S111 that the locus has not been input, if it is determined in S112 that the locus is not included in the peripheral region of the character key region X, or if it is determined in S113 that the first direction and the second direction do not have the predetermined relation to each other, as illustrated in FIG. 8, the microprocessor 44 determines whether or not the position pointed to by the user (pressed position) is included in a character key region 74 other than the character key region X (S114). If the position pointed to by the user is included in the character key region 74 other than the character key region X, the microprocessor 44 (first execution section 84) additionally stores the character corresponding to that character key region 74 in the string buffer (S115). After that, one is added to the value of the variable x (S109), and the answer field 62 of the answer screen 60 is updated (S110).

Further, the case in which it is determined in S106 that the string held in the string buffer does not match the above-mentioned part of the correct answer string means that the string already input by the user (string constituted by x characters) does not match part of the correct answer string from the beginning to the x-th character, that is, that the user is inputting a string different from the correct answer string. In such a case, as illustrated in FIG. 9, the microprocessor 44 determines whether or not the position pointed to by the user (pressed position) is included in any one of the character key regions 74 (S116). If the position pointed to by the user is included in any one of the character key regions 74, the microprocessor 44 (first execution section 84) additionally stores the character corresponding to that character key region 74 in the string buffer (S117). After that, one is added to the value of the variable x (S109), and the answer field 62 of the answer screen 60 is updated (S110).

If it is determined in S114 that the position pointed to by the user is not included in any character key region 74 other than the character key region X, or if it is determined in S116 that the position pointed to by the user is not included in any one of the character key regions 74, the microprocessor 44 determines whether or not the position pointed to by the user (pressed position) is included in the delete key region 76 (S118). If the position pointed to by the user is included in the delete key region 76, the microprocessor 44 deletes a character stored last from the string buffer (S119), and subtracts one from the value of the variable x (S120). After that, the answer field 62 of the answer screen 60 is updated (S110).

On the other hand, if it is determined in S118 that the position pointed to by the user is not included in the delete key region 76, the microprocessor 44 determines whether or not the position pointed to by the user (pressed position) is included in the OK key region 78 (S121). If the position pointed to by the user is included in the OK key region 78, the microprocessor 44 executes correct/incorrect determination processing (S122). Specifically, the microprocessor 44 refers to the string buffer, to thereby determine whether or not the string stored in the string buffer (answer input by the user) matches the correct answer string. If the string stored in the string buffer matches the correct answer string, that is, if the user's answer is correct, a point is added to the user's score. On the other hand, if the string stored in the string buffer (answer input by the user) does not match the correct answer string, that is, if the user's answer is incorrect, no point is added to the user's score. Note that in this case, a point may be subtracted from the user's score. Alternatively, in a case where the number of times when the user's answer is incorrect has reached a predetermined number, the game may end.

According to the game device 10, it is possible to allow the user who has figured out the correct answer to the quiz (user who is inputting an answer that is likely to be correct) to input their answer with greater ease, thereby enabling operability to be improved for the user.

Note that in the description above, the processing of S107, S108, S112, S113, and S114 of FIG. 7 and FIG. 8 is executed while only the character key region 74 corresponding to the x-th character of the correct answer string is set as the “character key region X”, but the processing may be executed while the character key regions 74 corresponding to all the characters included in the correct answer string are set as the “character key region X”.

Further, for example, in the answer screen 60, key images each corresponding to a character group to which a plurality of characters belong (hereinbelow, referred to as “character group keys”) may be displayed instead of the character keys 64. Then, after the user selects any one of the character group keys, the character keys 64 for the characters belonging to a character group corresponding to that character group key may be displayed in the answer screen 60. In this mode, character group key regions (reference regions), which are key regions corresponding to the respective character group keys, are set in the answer screen 60. Then, it is determined whether or not the position pointed to by the user is included in any one of the character group key regions, to thereby determine whether or not the user has pointed to a character group key. Further, based on a result of the determination, a string (answer) input by the user is acquired. In this mode, in S107, S108, S112, S113, and S114 of FIG. 7 and FIG. 8, the processing is executed for the character group key region (particular reference region) corresponding to the character group to which the x-th character of the correct answer string belongs, instead of for the character key region X. Even with this configuration, it is possible to allow the user who has figured out the correct answer to the quiz (user who is inputting an answer that is likely to be correct) to input their answer with greater ease.

Further, as described above, description has been given of, as an example, the case in which the correct answer to the quiz is a string represented by one or a plurality of characters of the alphabet. That is, the case in which the user inputs characters of the alphabet in the answer screen 60 has been described. However, the present invention is also applicable to a case in which the correct answer to the quiz is a string represented by characters other than the alphabet. Further, the present invention is also applicable to a case in which the correct answer to the quiz is a symbol sequence represented by signs (narrowly-defined symbols), pictograms, or the like other than characters. Specifically, the present invention is applicable to a case in which the user inputs, on the answer screen 60, numbers, hiragana, katakana, kanji, characters for a language other than the Japanese language (Chinese language, Korean language, or the like), signs (narrowly-defined symbols), pictograms, or the like, for example.

### Second Embodiment

An outer appearance and a hardware configuration of a game device according to a second embodiment of the present invention are the same as in the first embodiment (FIGS. 1 to 3), and hence description thereof is omitted herein. Also in this embodiment, a quiz game is executed based on a program read from the game memory card 40. Note that the quiz game according to this embodiment is such a quiz game that the user selects, from among a plurality of options, an option which the user thinks is correct.

Also in this quiz game, a question screen showing a quiz question is displayed on the second liquid crystal display unit 32, whereas an answer screen for the user to input their answer to the quiz is displayed on the touch screen 22. FIG. 13 illustrates an example of the answer screen. As illustrated in FIG. 13, a plurality of option images 64a are displayed on an answer screen 60a according to this embodiment. In the example illustrated in FIG. 13, the option images 64a corresponding to nine options A to I are displayed. In the answer screen 60a, the user selects any one of the options (option images 64a) to answer the quiz.

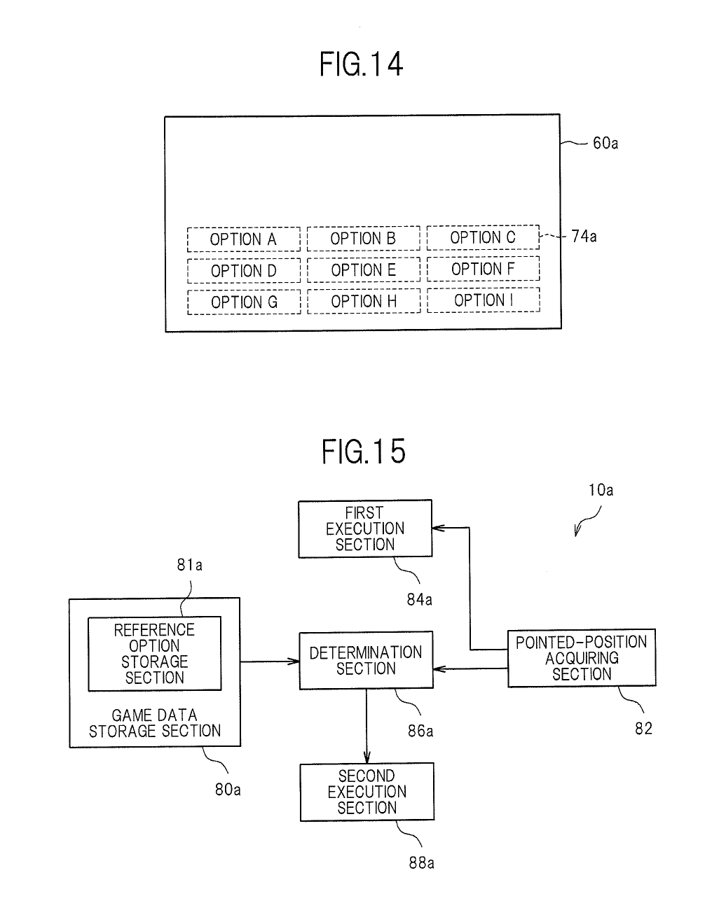

Further, option regions (reference regions), which are regions corresponding to the respective option images 64a, are set in the answer screen 60a. FIG. 14 illustrates an example of the option regions set in the answer screen 60a. As illustrated in FIG. 14, option regions 74a corresponding to the respective option images 64a are set. The option regions 74a are set so as not to overlap each other. For example, an option region 74a is set so as to coincide with a region occupied by the option image 64a corresponding to that option region 74a. In a case where the position pointed to by the user is included in any one of the option regions 74a, it is determined that the option (option image 64a) corresponding to that option region 74a has been selected. In this case, it is determined whether or not the option selected by the user is correct.

Note that in the example illustrated in FIG. 13 and FIG. 14, the option images 64a and the option regions 74a have rectangular shapes, but the option images 64a and the option regions 74a may have a shape other than a rectangle (for example, circle).

Hereinbelow, description is given of a technology for allowing the user to select an option with greater ease.

FIG. 15 is a functional block diagram illustrating, of functions implemented in a game device 10a according to the second embodiment, functions relevant to the present invention. Note that, a functional block having the same function as in the first embodiment is denoted by the same reference numeral, and description thereof is omitted herein. As illustrated in FIG. 15, the game device 10a includes a game data storage section 80a, a pointed-position acquiring section 82, a first execution section 84a, a determination section 86a, and a second execution section 88a. The game data storage section 80a is implemented by, for example, the game memory card 40 or the main memory 46, and the other functional blocks are implemented by the microprocessor 44 executing the programs read from the game memory card 40.

The game data storage section 80a stores various kinds of data regarding the quiz game. For example, data indicating the positions of the option images 64a and of the option regions 74a are stored in the game data storage section 80a. Further, the game data storage section 80a includes a reference option storage section 81a. The reference option storage section 81a stores a reference option. In this embodiment, the reference option storage section 81a stores a plurality of pieces of quiz data. The quiz data includes a string indicating a quiz question, a plurality of options to be presented to the user, and an option which is the correct answer to the quiz. In this case, the option which is the correct answer to the quiz corresponds to the “reference option”.

If a position acquired by the pointed-position acquiring section 82 is included in a certain option region 74a (here, referred to as “option region A”), the first execution section 84a executes processing corresponding to the option region A. For example, processing related to the option corresponding to the option region A is executed. Specifically, processing of determining whether or not the option corresponding to the option region A matches the reference option is executed.

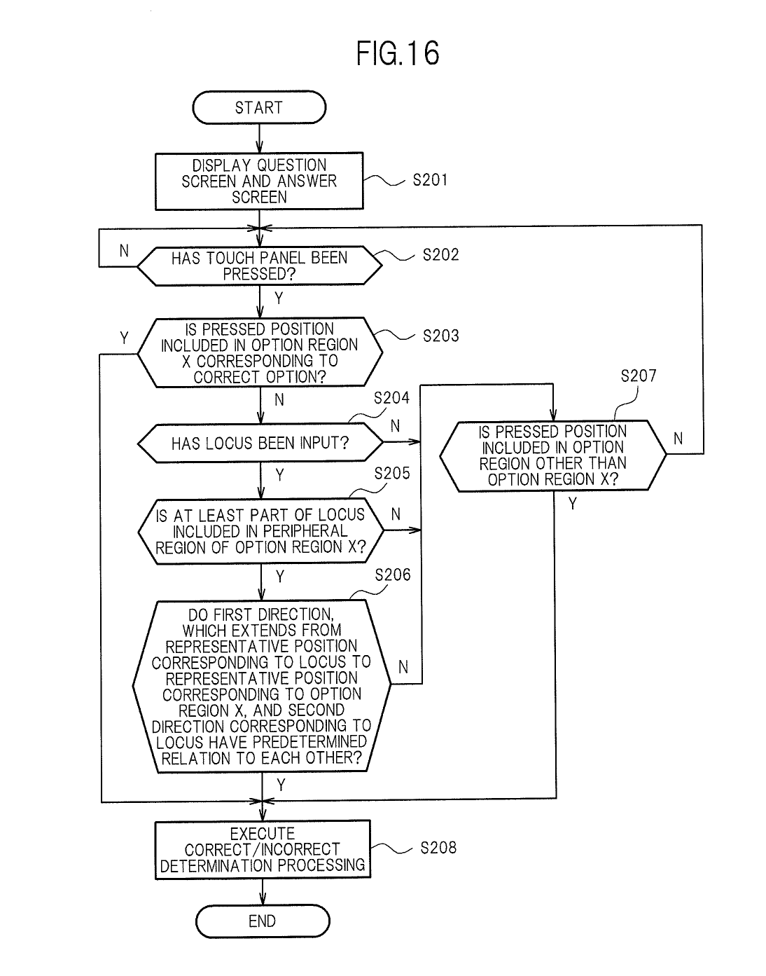

If an input of a locus having a start point positioned outside the option region A is received, that is, if a locus of the positions acquired by the pointed-position acquiring section 82 has the start point thereof positioned outside the option region A, the determination section 86a determines whether or not the locus and the option region A have a predetermined relation to each other. Details of operation of the determination section 86a are described later (see S205 and S206 of FIG. 16).

If it is determined by the determination section 86a that the locus and the option region A have the predetermined relation to each other, the second execution section 88a executes processing corresponding to the option region A. Specifically, the same processing as the processing executed by the first execution section 84a in a case where the position acquired by the pointed-position acquiring section 82 is included in the option region A is executed.

Next, description is given of processing executed by the game device 10a according to the second embodiment. FIG. 16 is a flow chart illustrating the processing executed by the game device 10a. The microprocessor 44 executes the processing illustrated in FIG. 16 according to the program read from the game memory card 40.

As illustrated in FIG. 16, first, the microprocessor 44 displays a question screen on the second liquid crystal display unit 32, and displays the answer screen 60a on the touch screen 22 (S201). In this processing, any one of the plurality of pieces of quiz data stored in the game memory card 40 is read, and a quiz question is displayed on the question screen. After that, the microprocessor 44 monitors whether or not the user has pressed the touch panel 22b (S202). If the touch panel 22b has been pressed, the microprocessor 44 (pointed-position acquiring section 82) acquires the pressed position as the position pointed to by the user. Then, the microprocessor 44 determines whether or not the position pointed to by the user (pressed position) is included in an option region 74a corresponding to the correct option (hereinbelow, referred to as “option region X”) (S203). If the position pointed to by the user is included in the option region X, the microprocessor 44 (first execution section 84a) executes the correct/incorrect determination processing (S208). Specifically, in this case, it is determined that the user has selected the option corresponding to the option region X. Then, it is determined whether or not the option selected by the user matches the correct option. If the option selected by the user matches the correct option, a point is added to the user's score. On the other hand, if the option selected by the user does not match the correct option, no point is added to the user's score.

On the other hand, if the position pointed to by the user is not included in the option region X, the microprocessor 44 determines whether or not the locus has been input (S204). This processing is the same as the processing of S111 of FIG. 8. If the locus has been input, the microprocessor 44 (determination section 86a) determines whether or not at least part of the locus is included in a peripheral region of the option region X (S205). The peripheral region of the option region X is set in the same manner as the peripheral region 92 of the character key region X 74X illustrated in FIG. 11. If at least part of the locus is included in the peripheral region of the option region X, the microprocessor 44 (determination section 86a) determines whether or not a first direction, which extends from a representative position corresponding to the locus to a representative position corresponding to the option region X, and a second direction corresponding to the locus, have a predetermined relation to each other (S206). This processing is the same as the processing of S113 of FIG. 8 (see FIG. 12). For example, in the processing of S206, it is determined whether or not an angle formed between the first direction, which extends from the representative position of the locus (for example, start point of the locus) to the representative position of the option region X (for example, center point of the option region), and the second direction indicated by the locus, is less than a reference angle. Note that as the second direction indicated by the locus, for example, a direction that extends from a first position on the locus (for example, start point of the locus) to a second position on the locus (for example, end point of the locus) is used. In this case, the second position is such a position on the locus that is pointed to later than the first position.

If the first direction and the second direction have the predetermined relation to each other, the microprocessor 44 (second execution section 88a) executes the same processing as the processing executed in a case where it is determined in S203 that the position pointed to by the user is included in the option region X. Specifically, in this case, it is considered that the user has selected the option corresponding to the option region X, and the correct/incorrect determination processing is executed (S208).

Note that, if it is determined in S204 that the locus has not been input, if it is determined in S205 that the locus is not included in the peripheral region of the option region X, or if it is determined in S206 that the first direction and the second direction do not have the predetermined relation to each other, the microprocessor 44 determines whether or not the position pointed to by the user (pressed position) is included in an option region 74a other than the option region X (S207). If the position pointed to by the user is included in an option region 74a other than the option region X, the microprocessor 44 (first execution section 84a) determines that the user has selected the option corresponding to that option region 74a, and then executes the correct/incorrect determination processing (S208).

A case in which all the above-mentioned conditions of S204 to S206 are satisfied means that the user has failed to point to a position in the option region X corresponding to the correct option, but has pointed to a position in the vicinity of the option region X and moved the stylus pen or their thumb or finger toward the option region X. In such a case, it is conceivable that the user intends to point to a position in the option region X. In other words, it is conceivable that the user intends to select the correct option. In this respect, according to this embodiment, if all the conditions of S204 to S206 are satisfied, the user is considered to intend to point to a position in the option region X, and hence the same processing as the processing executed in a case where the user has pointed to a position in the option region X is executed. Specifically, it is determined that the option corresponding to the option region X has been selected, and the correct/incorrect determination processing is executed. According to the game device 10a of the second embodiment, it is easier for the user who has figured out the correct answer to the quiz (user who is inputting an answer that is likely to be correct) to input their answer. As a result, operability can be improved for the user.

By the way, similarly to the case of the characters and the character groups of the first embodiment, in the answer screen 60a, images each corresponding to an option group to which a plurality of options belong may be displayed instead of the option images 64a. Then, if the user has selected any one of the option groups, the option images 64a for the options belonging to that option group may be displayed in the answer screen 60a. In this mode, option group regions (reference regions), which are regions corresponding to the respective option groups, are set in the answer screen 60a. Then, it is determined whether or not the position pointed to by the user is included in any one of the option group regions, to thereby determine whether or not the user has selected an option group. Further, based on a result of the determination, the option selected by the user (answer) is determined. In this mode, in S203, S205, S206, and S207 of FIG. 16, the processing is executed for the option group region (particular reference region) corresponding to the option group to which the correct option belongs, instead of for the option region X. Even with this configuration, it is possible to allow the user who has figured out the correct answer to the quiz (user who is inputting an answer that is likely to be correct) to input their answer with greater ease.

### MODIFICATION EXAMPLE

Note that, the present invention is not limited to the embodiments described above.

For example, operation means used by the user for pointing to a position on the screen is not limited to the touch panel 22b, and may be, for example, a game controller, a mouse, or the like. For example, by displaying a cursor which moves according to an operation of the cross-shaped button 24c on the answer screen 60 or 60a, the user may be allowed to point to a position on the answer screen 60 or 60a by using the cross-shaped button 24c.

Further, for example, the present invention is applicable to the game devices 10 or 10a that execute a game other than the quiz game. Further, the present invention is also applicable to an information processing device other than the game devices 10 and 10a. The present invention is applicable to an information processing device that executes processing based on a result of comparison between a symbol sequence (for example, string) input by the user and a reference symbol sequence (for example, reference string). Then, according to the present invention, it is possible to allow the user who is inputting the reference symbol sequence to input the reference symbol sequence with greater ease. Further, the present invention is applicable to an information processing device that executes processing based on a result of comparison between an option selected by the user and a reference option. Then, according to the present invention, it is possible to allow the user who is selecting an option serving as the reference option to select the option with greater ease.

1. An information processing device, comprising:
first execution means for executing, if an input of a position in a reference region that is set on a screen is received, processing corresponding to the reference region;
determination means for determining, if an input of a locus having a start point thereof positioned outside the reference region is received, whether or not the locus and the reference region have a predetermined relation to each other; and
second execution means for executing, if it is determined that the locus and the reference region have the predetermined relation to each other, the processing corresponding to the reference region.

2. The information processing device according to claim 1, further comprising reference symbol sequence storage means for storing a reference symbol sequence including one or a plurality of symbols, wherein:
a plurality of the reference regions each corresponding to a symbol or a symbol group are set on the screen;
the first execution means executes, if an input of a position in any one of the plurality of the reference regions is received, processing related to the symbol or the symbol group corresponding to the any one of the plurality of the reference regions;
the determination means determines, if an input of a locus having a start point thereof positioned outside a particular reference region is received, whether or not the locus and the particular reference region have the predetermined relation to each other, the particular reference region being the reference region corresponding to the symbol included in the reference symbol sequence or the reference region corresponding to the symbol group to which the symbol included in the reference symbol sequence belongs; and
the second execution means executes, if it is determined that the locus and the particular reference region have the predetermined relation to each other, the processing related to the symbol or the symbol group corresponding to the particular reference region.

3. The information processing device according to claim 2, wherein, if a user inputs an x-th symbol, where x is an integer equal to or larger than 1, the particular reference region is the reference region corresponding to the x-th symbol of the reference symbol sequence or the reference region corresponding to the symbol group to which the x-th symbol of the reference symbol sequence belongs.

4. The information processing device according to claim 2, wherein:
the determination means comprises:
first determination means for determining whether or not at least part of the locus is included in a peripheral region that is set on a periphery of the particular reference region; and
second determination means for determining whether or not a first direction, which extends from a representative position corresponding to the locus to a representative position corresponding to the particular reference region, and a second direction corresponding to the locus, have the predetermined relation to each other; and
the second execution means executes, if it is determined that the at least part of the locus is included in the peripheral region and that the first direction and the second direction have the predetermined relation to each other, the processing corresponding to the particular reference region.

5. The information processing device according to claim 1, further comprising reference option storage means for storing a reference option, wherein:
a plurality of the reference regions each corresponding to an option or an option group are set on the screen;
the first execution means executes, if an input of a position in any one of the plurality of the reference regions is received, processing related to the option or the option group corresponding to the any one of the plurality of the reference regions;
the determination means determines, if an input of a locus having a start point thereof positioned outside a particular reference region is received, whether or not the locus and the particular reference region have the predetermined relation to each other, the particular reference region being the reference region corresponding to the option serving as the reference option or the reference region corresponding to the option group to which the option serving as the reference option belongs; and
the second execution means executes, if it is determined that the locus and the particular reference region have the predetermined relation to each other, the processing related to the option or the option group corresponding to the particular reference region.

6. The information processing device according to claim 5, wherein:
the determination means comprises:
first determination means for determining whether or not at least part of the locus is included in a peripheral region that is set on a periphery of the particular reference region; and
second determination means for determining whether or not a first direction, which extends from a representative position corresponding to the locus to a representative position corresponding to the particular reference region, and a second direction corresponding to the locus, have the predetermined relation to each other; and
the second execution means executes, if it is determined that the at least part of the locus is included in the peripheral region and that the first direction and the second direction have the predetermined relation to each other, the processing corresponding to the particular reference region.

7. A method of controlling an information processing device, comprising:
a first execution step of executing, if an input of a position in a reference region that is set on a screen is received, processing corresponding to the reference region;
a determination step of determining, if an input of a locus having a start point thereof positioned outside the reference region is received, whether or not the locus and the reference region have a predetermined relation to each other; and
a second execution step of executing, if it is determined that the locus and the reference region have the predetermined relation to each other, the processing corresponding to the reference region.

8. A program for causing a computer to function as:
first execution means for executing, if an input of a position in a reference region that is set on a screen is received, processing corresponding to the reference region;
determination means for determining, if an input of a locus having a start point thereof positioned outside the reference region is received, whether or not the locus and the reference region have a predetermined relation to each other; and
second execution means for executing, if it is determined that the locus and the reference region have the predetermined relation to each other, the processing corresponding to the reference region.

9. A computer-readable information storage medium storing a program, the program causing a computer to function as:
first execution means for executing, if an input of a position in a reference region that is set on a screen is received, processing corresponding to the reference region;
determination means for determining, if an input of a locus having a start point thereof positioned outside the reference region is received, whether or not the locus and the reference region have a predetermined relation to each other; and
second execution means for executing, if it is determined that the locus and the reference region have the predetermined relation to each other, the processing corresponding to the reference region.
